(19) United States
(12) Patent Application Publication
(10) Pub. No.: US 2009/0225029 A1
(43) Pub. Date: Sep. 10, 2009

(54) Battery cover of wireless mouse

(76) Inventor: Cheng-Cheng Wu, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/073,373

(22) Filed: Mar. 5, 2008

(51) Int. Cl. G06F 3/033

(52) U.S. Cl. 345/163

(57) ABSTRACT

A battery cover of a wireless mouse is provided in a body of the wireless mouse. The body has a battery accommodating chamber. The battery cover includes a plate, an accommodating trough, an insertion hole and at least one fixing portion. The plate covers the battery accommodating chamber of the body. The accommodating trough is recessed in the plate. The insertion hole is provided in the plate and in communication with the accommodating trough. The fixing portion extends from side walls of the insertion hole. Via this arrangement, the accommodating trough of the present invention can accommodate a wireless receiver.

### BACKGROUND OF THE INVENTION

1. Field of the Invention

The present invention is related to a wireless mouse, and in particular to a battery cover of a wireless mouse for accommodating a wireless receiver.

2. Description of Related Art

With the coming of wireless digital era, many wireless mice are available in the market. Although the wireless mouse has dispensed with a signal cable, it is still necessary to provide a wireless receiver to receive the signals relating to the movement of the wireless mouse. The wireless receiver is inserted into a personal computer during operation, but the wireless receiver can cause inconvenience for the user during transportation and storage of mouse and receiver. Thus, those skilled in this art have proposed accommodating the wireless receiver in the mouse to facilitate transportation and storage.

Taiwan Patent Publication No. 00584252 discloses a wireless mouse capable of receiving a receiver, which includes a receiver and a mouse body. The mouse body has a base, a middle frame and an upper cover. The middle frame is mounted on the base and is provided with a first space for accommodating the receiver. The upper cover covers the middle frame. Via this arrangement, the receiver can be accommodated in the mouse body. With the covering of the upper cover, the receiver can be accommodated in the mouse body completely.

However, it is necessary to open/close the upper cover to take in/out the receiver. Further, the receiver accommodated in the mouse body may occupy the internal space of the mouse body, which makes it difficult to arrange other elements. As a result, the volume of the mouse body cannot be reduced easily.

Therefore, in practice, the conventional receiver of a wireless mouse has some inconvenience and drawbacks, and thus needs to be improved.

Consequently, because of the above technical defects, the inventor keeps on carving unflaggingly through wholehearted experience and research to develop the present invention, which can effectively improve the defects described above.

### SUMMARY OF THE INVENTION

The object of the present invention is to provide a battery cover of a wireless mouse, in which an accommodating trough is formed for accommodating a wireless receiver. Via this arrangement, the wireless receiver can be avoided from occupying the internal space of the wireless mouse.

In order to achieve the above objects, the present invention provides a battery cover of a wireless mouse, which is provided in a body of the wireless mouse. The body has a battery accommodating chamber. The battery cover includes: a plate for covering the battery accommodating chamber of the body; an accommodating trough recessed in the plate; an insertion hole provided in the plate and in communication with the accommodating trough; and at least one fixing portion extending from side walls forming the insertion hole.

The body further has a circuit board that is electrically connected to a power switch. The accommodating trough allows a wireless receiver to be disposed therein. The wireless receiver has a front end that extends into the insertion hole to turn off the power switch. The fixing portion fixes the front end of the wireless receiver, thereby fixing the wireless receiver in the plate.

The present invention has advantageous effects as follows. The body has a circuit board that is electrically connected to a power switch. The plate is provided with an accommodating trough for accommodating the wireless receiver. The insertion hole of the plate allows the front end of the wireless receiver to be extended therein to turn off the power switch, thereby saving electricity. Further, in comparison with prior art that the wireless receiver is disposed in the wireless mouse, the present invention utilizes the fixing portion to fix the front end of the wireless receiver, and thus it is unnecessary to provide an upper cover on the wireless mouse. This arrangement may not cause any inconvenience to the user and will not occupy the internal space of the wireless mouse. As a result, it is more advantageous to reduce the overall volume of the wireless mouse and arrange other elements therein.

In order to further understand the characteristics and technical contents of the present invention, a detailed description relating thereto will be made with reference to the accompanying drawings. However, the drawings are illustrative only, but not used to limit the scope of the present invention.

### BRIEF DESCRIPTION OF THE DRAWINGS

FIG. 1 is an exploded perspective view showing the battery cover of a wireless mouse in accordance with a first embodiment of the present invention;

FIG. 2 is a perspective view showing a portion of elements of the battery cover of a wireless mouse in accordance with a first embodiment of the present invention along another viewing angle;

FIG. 3 is an assembled perspective view showing the battery cover of a wireless mouse in accordance with a first embodiment of the present invention;

FIG. 4 is a schematic view showing the operating state of the battery cover of a wireless mouse in accordance with a first embodiment of the present invention;

FIG. 5 is an exploded perspective view showing the battery cover of a wireless mouse in accordance with a second embodiment of the present invention;

FIG. 6 is a perspective view showing a portion of elements of the battery cover of a wireless mouse in accordance with a second embodiment of the present invention along another viewing angle;

FIG. 7 is an assembled perspective view showing the battery cover of a wireless mouse in accordance with a second embodiment of the present invention; and

FIG. 8 is a schematic view showing the operating state of the battery cover of a wireless mouse in accordance with a second embodiment of the present invention.

### DETAILED DESCRIPTION OF THE PREFERRED EMBODIMENTS

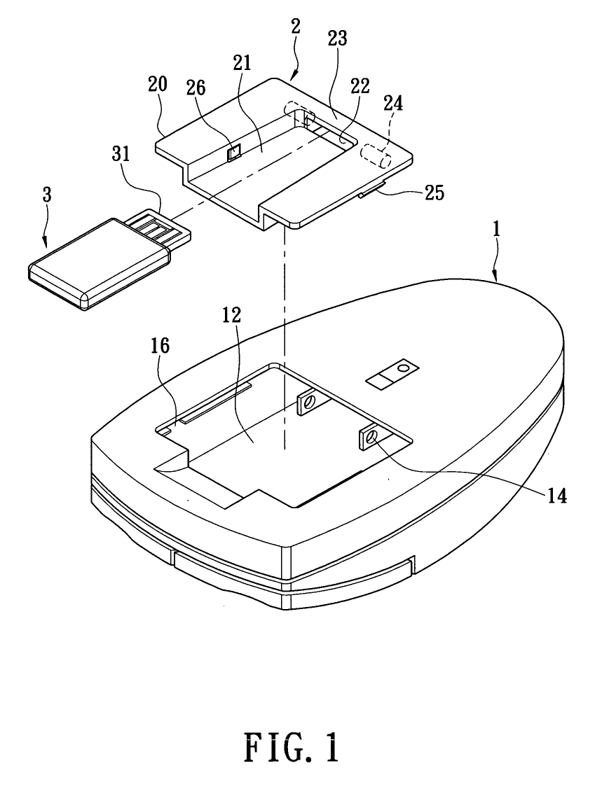

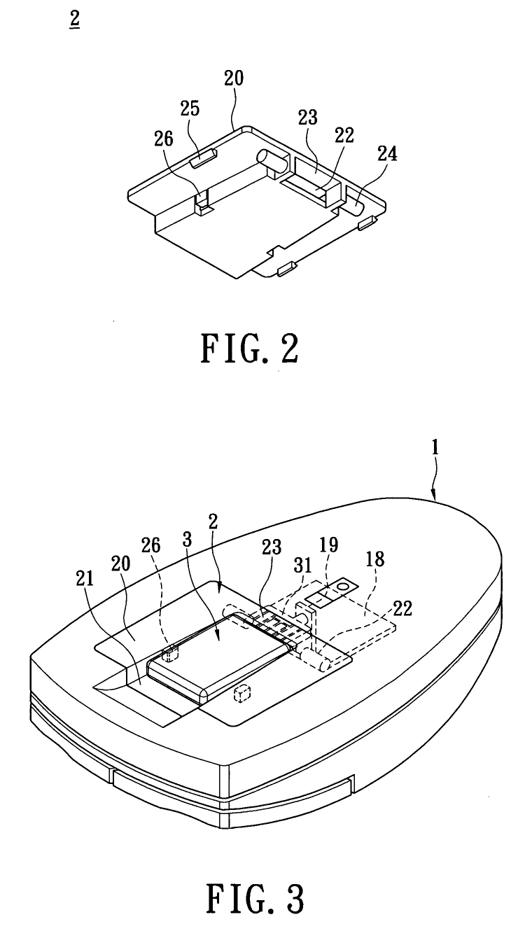

Please refer to FIGS. 1 and 2. The present invention provides a battery cover 2 of a wireless mouse, which is provided in a body 1 of the wireless mouse. The battery cover 2 includes a plate 20, an accommodating trough 21, an insertion hole 22, and a fixing portion 23.

The bottom of the body 1 of the wireless mouse is provided with a battery accommodating chamber 12 for accommodating an electricity unit such as a battery (not shown), thereby providing the necessary electricity for the wireless mouse.

The surface of the plate 20 is recessed to form the accommodating trough 21. One side of the plate 20 is provided with the insertion hole 22 that is in communication with the accommodating trough 21. The fixing portion 23 is formed by means of extending from a side wall surface forming the insertion hole 22.

The plate 20 covers the battery accommodating chamber 12 of the body 1 in such a manner that it can be pivotally lifted from or cover the bottom of the body 1. Alternatively, the plate can be engaged in the bottom of the body 1.

More specifically, as shown in FIGS. 1 to 3, in the case of pivotal connection, both sides of the plate 20 are provided with a pivot 24 respectively. The body 1 is provided thereon with two pivotal holes 14 for corresponding to the two pivots 24, thereby pivotally connecting the plate 20 to the bottom of the body 1. Further, both sides of the plate 20 extend to form hooks 25 that correspond to troughs 16 formed on sides of the body 1. Via the above arrangement, when the plate 20 covers the bottom of the body 1, the engagement of the hooks 25 with the troughs 16 can allow the plate 20 to be fixed to the body 1. The pivotal connection in the present invention is not limited to the above way as long as the plate 20 can be pivotally connected to the body 1.

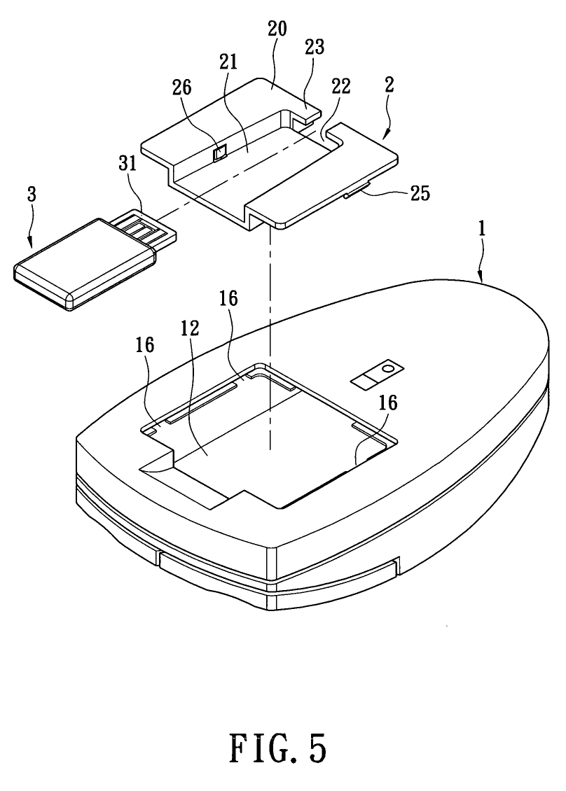

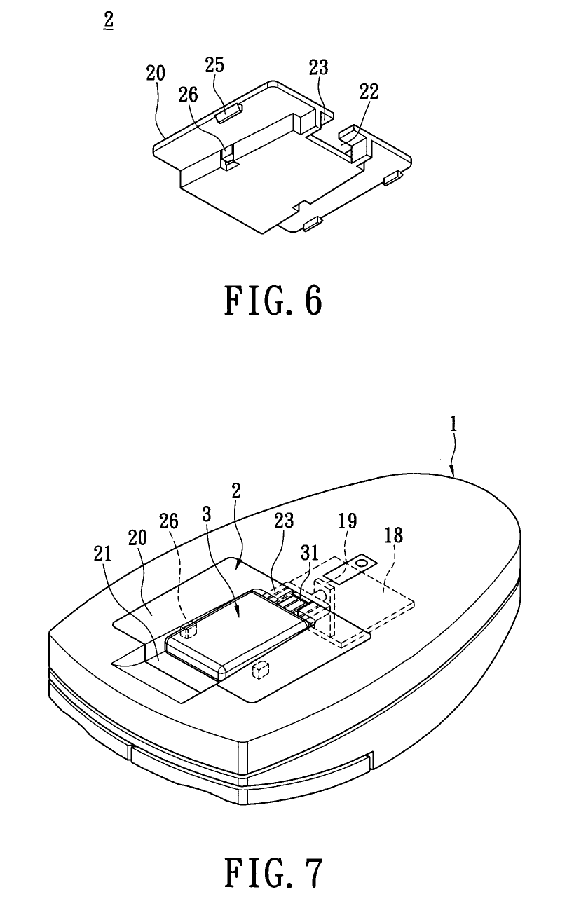

Alternatively, as shown in FIGS. 5 to 7, in the present embodiment, the pivots 24 and the pivotal holes 14 mentioned in the previous embodiment are not provided. Instead, hooks 25 are formed on both sides of the plate 20. With the hooks being hooked in the corresponding troughs 16 of the body 1, the plate 20 can be engaged in the bottom of the body 1.

In the present embodiment, the accommodating trough 21 of the plate 20 can accommodate a wireless receiver 3. The wireless receiver 3 has a front end 31. When the wireless mouse is to be connected with a personal computer, the front end 31 of the wireless receiver 3 is inserted into a USB port (not shown) of the personal computer. In this way, the signals of the wireless mouse can be transmitted to the personal computer.

Please refer to FIGS. 3 and 7. The body 1 further has a circuit board 18 that is electrically connected with a power switch 19. When the wireless receiver 3 is to be stored, it can be inserted into the accommodating trough 21 of plate 20 with the front end 31 of the wireless receiver 3 extending into the insertion hole 22 to contact and turn off the power switch 19, thereby saving electricity. At the same time, the fixing portion 23 can fix the front end 31 of the wireless receiver 3, thereby fixing the wireless receiver 3 in the accommodating trough 21 of the plate 20 firmly.

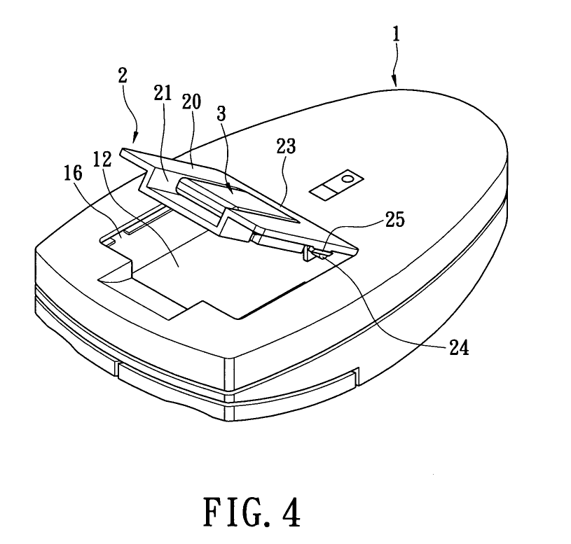

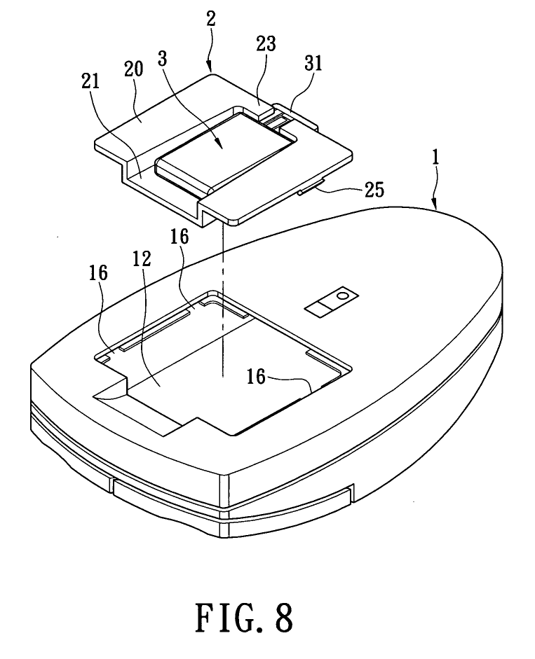

Further, in the embodiment of the present invention shown in FIGS. 1 to 4, only one fixing portion 23 is provided, which is integrally connected to both side wall surfaces of the insertion hole 22. Alternatively, as shown in FIGS. 5 to 8, two fixing portions 23 are provided, which extend from the side wall surfaces of the insertion hole

Further, an elastic arm 26 extends from a side wall of the accommodating trough 21 for abutting against a side wall of the wireless receiver 3 elastically, thereby fixing the wireless receiver 3 more firmly.

According to the above, in the battery cover 2 of the wireless mouse, the plate 20 covers the battery accommodating chamber 12 provided in the bottom of the body 1. The plate 20 is provided with an accommodating trough 21 for accommodating a wireless receiver 3. The insertion hole 22 of the plate 20 allows a front end 31 of the wireless receiver 3 to be extended therein to turn off the power switch 19, thereby saving electricity. Further, in comparison with prior art that the wireless receiver is disposed in the wireless mouse, the present invention utilizes the fixing portion 23 to fix the front end 31 of the wireless receiver 3, and thus it is unnecessary to provide an upper cover on the wireless mouse. This arrangement may not cause any inconvenience to the user and will not occupy the internal space of the wireless mouse. As a result, it is more advantageous to reduce the overall volume of the wireless mouse and arrange other elements therein.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A battery cover of a wireless mouse, the wireless mouse consisting of a wireless receiver and a tracking device contained in a body, wherein the body has a battery accommodating chamber, the battery cover is provided on the body and comprises:
a plate for covering the battery accommodating chamber;
an accommodating trough recessed in the plate;
an insertion hole provided in the plate and in communication with the accommodating trough; and
at least one fixing portion extending from side walls forming the insertion hole.

2. The battery cover of a wireless mouse according to claim 1, wherein the accommodating trough accommodates the wireless receiver, the wireless receiver has a front end extending into the insertion hole, and the fixing portion fixes the front end of the wireless receiver.

3. The battery cover of a wireless mouse according to claim 2, wherein the body further has therein a circuit board electrically connected to a power switch, the front end of the wireless receiver extends into the insertion hole to contact and turn off the power switch.

4. The battery cover of a wireless mouse according to claim 2, wherein one fixing portion is integrally connected to both side wall surfaces forming the insertion hole.

5. The battery cover of a wireless mouse according to claim 2, wherein two fixing portions are provided extending from the side wall surfaces forming the insertion hole.

6. The battery cover of a wireless mouse according to claim 2, wherein an elastic arm extends from a side wall of the accommodating trough, and the elastic arm abuts against a side wall of the wireless receiver elastically.

7. The battery cover of a wireless mouse according to claim 2, wherein the plate is pivotally connected to the body in such a manner that the plate is able to open and close.

8. The battery cover of a wireless mouse according to claim 2, wherein the plate is engaged in the body.
